(19) United States
(12) Patent Application Publication
(10) Pub. No.: US 2008/0177454 A1
(43) Pub. Date: Jul. 24, 2008

(54) Integrated trailer brake control system

(76) Inventors: James R. Bond, Centerville, OH (US); Daniel N. Borgemenke, Springboro, OH (US); Matthew A. Cukovecki, New Carlise, OH (US)

Correspondence Address: DELPHI TECHNOLOGIES, INC., M/C 480-410-202, PO BOX 5052, TROY, MI, 48007, US

(21) Appl. No.: 11/654,919

(22) Filed: Jan. 18, 2007

(51) Int. Cl. B60T 8/172

(52) U.S. Cl. 701/70

(57) ABSTRACT

A control system for actuating a trailer braking system on a trailer is disclosed. The control system includes a trailer brake controller in communication with an antilock braking controller and an electronic stability controller of a towing vehicle to receive a wheel speed, a brake pressure, a yaw rate, a lateral acceleration, and a steering angle. The trailer brake controller utilizes the wheel speed, the brake pressure, the yaw rate, the lateral acceleration, and the steering angle to determine the attitude of the towing vehicle, and to calculate a desired braking force for the trailer. The trailer brake controller sends an appropriate output to actuate the trailer braking system on the trailer to stabilize the towing vehicle during extreme braking conditions.

### BACKGROUND OF THE INVENTION

1. Field of the Invention

The subject invention provides a control system for actuating a brake on a trailer towed by a towing vehicle, and a method of actuating the brake on the trailer.

2. Description of the Prior Art

Many trailers include a trailer braking system controlled by a trailer brake controller located within a cabin of a towing vehicle. Typically, this type of trailer brake controller is coupled to the trailer brake system and provides an electrical signal to actuate the trailer braking system. Traditionally, the trailer brake controller was an aftermarket device installed in the towing vehicle. The trailer brake controller was connected to a braking system on the towing vehicle to receive a braking input upon application of the towing vehicles braking system. Upon receiving the braking input, indicating that the towing vehicle's brakes had been activated, the trailer brake controller would send an output signal to activate the trailer braking system as well. The trailer brake controller disengaged the output signal to deactivate the trailer braking system when the brake on the towing vehicle is deactivated.

As disclosed in U.S. Pat. No. 6,966,613 to Davis, the trailer brake controller is in communication with an antilock braking system incorporated into the towing vehicle to improve performance of the trailer braking system. The trailer brake controller is in communication with a wheel speed sensor of the antilock braking system located at each wheel of the towing vehicle, and receives a wheel speed input from each wheel speed sensor. The trailer brake controller is also in communication with a brake pressure sensor of the antilock braking system, disposed near the master cylinder of the towing vehicle, and receives a brake pressure input therefrom. The trailer brake controller utilizes a software program responsive to the wheel speed input and the brake pressure input to control the output, thereby customizing the output to the trailer braking system. While coupling the trailer brake controller to the antilock braking system of the towing vehicle improved the performance of the trailer braking system, the wheel speed of each of the wheels on the towing vehicle are often affected by the trailer pushing on the towing vehicle, thereby reducing the effectiveness of this type of system during extreme braking conditions.

### SUMMARY OF THE INVENTION AND ADVANTAGES

The subject invention provides a method of actuating a brake on a trailer towed by a towing vehicle. The towing vehicle includes a trailer brake controller having a processor with a memory. The method comprises the steps of determining a yaw rate of the towing vehicle relative to a yaw axis of the towing vehicle; determining a lateral acceleration of the towing vehicle relative to a pitch axis of the towing vehicle; determining a steering angle of the towing vehicle; inputting the yaw rate, the lateral acceleration, and a steering angle into the memory of the processor; calculating a desired braking force for the brake on the trailer in response to the inputted yaw rate, the inputted lateral acceleration, and the inputted steering angle; and sending an output to the brake on the trailer commensurate with the desired braking force to actuate the brake.

The subject invention also provides a control system for actuating the brake on the trailer towed by the towing vehicle. The control system comprises an electronic stability controller. The electronic stability controller includes a yaw rate sensor, a lateral acceleration sensor, and a steering angle sensor for gathering data on a change in attitude of the towing vehicle relative to a yaw axis and a pitch axis of the towing vehicle. The control system further comprises a trailer brake controller. The trailer brake controller includes a processor having a memory, and is in communication with the electronic stability controller for receiving data associated with the yaw rate from the yaw rate sensor, the lateral acceleration from the lateral acceleration sensor, and the steering angle from the steering angle sensor. The trailer brake controller calculates a desired braking force for the brake on the trailer. An output is responsive to the yaw rate, the lateral acceleration, and the steering angle and is commensurate in magnitude with the desired braking force. The output coordinates the actuation of the brake on the trailer with the attitude of the towing vehicle.

Accordingly, the subject invention utilizes the sensors of the electronic stability control that are incorporated into the towing vehicle to provide the data necessary for the trailer brake controller to apply the brakes on the trailer appropriately based on the attitude of the vehicle, thereby increasing the stability of the towing vehicle during extreme braking conditions.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a schematic diagram of a towing vehicle and a trailer; and

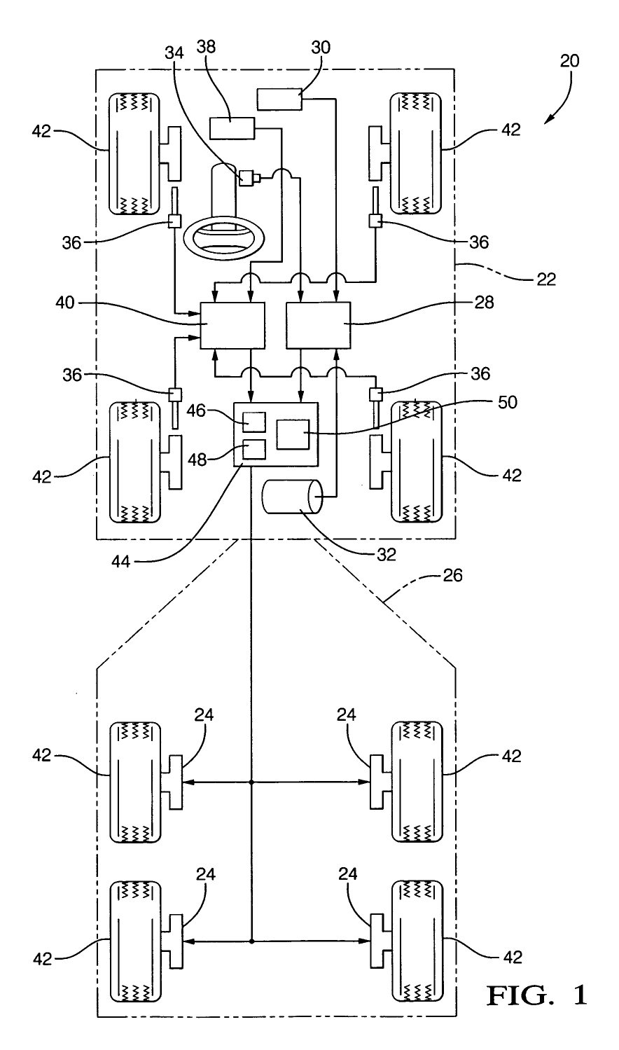

FIG. 2 is front view of an automotive dash assembly showing an integrated trailer brake controller.

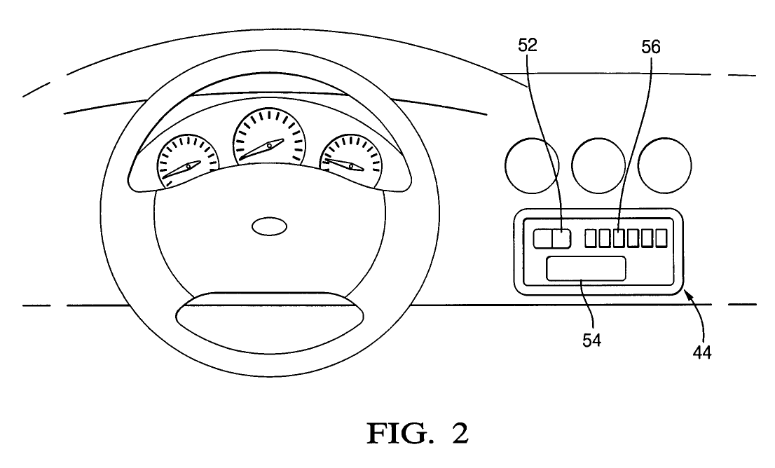

FIG. 3 is a perspective schematic view of the towing vehicle showing a yaw axis and a pitch axis

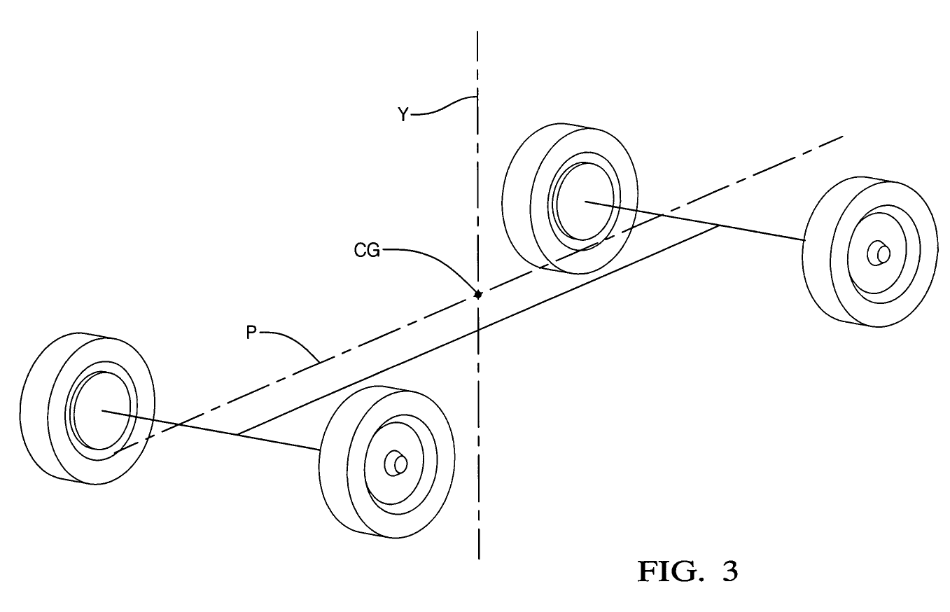

### DETAILED DESCRIPTION OF THE INVENTION

Referring to the Figures, wherein like numerals indicate corresponding parts throughout the several views, a control system is generally shown at 20. The control system 20 is preferably integrated into a towing vehicle 22, and actuates a braking system 24, or a brake, on a trailer 26 towed by the towing vehicle 22.

The control system 20 comprises an electronic stability controller 28. The electronic stability controller 28 is preferably integrated into the towing vehicle 22 and includes a plurality of various sensors for gathering data on a change in attitude of the towing vehicle 22 relative to a yaw axis Y of the towing vehicle 22 and a pitch axis P of the towing vehicle 22.

The yaw axis Y, as is commonly understood in the art, is perpendicular to a horizontal plane extending through the center of gravity CG of the towing vehicle 22. The attitude of the towing vehicle 22 includes the position, or change in position over time of the towing vehicle 22 about the yaw axis Y. In other words, the attitude of the towing vehicle 22 will change relative to the yaw axis Y if the towing vehicle 22 is turning or is in a rotational spin. The pitch axis P extends thought the center of gravity CG of the towing vehicle 22, perpendicular to the yaw axis Y and parallel to the horizontal plane. The attitude of the towing vehicle 22 further includes the position, or change in position over time of the towing vehicle 22 about the pitch axis P. In other words, the attitude of the towing vehicle 22 will change relative to the pitch axis P if the towing vehicle 22 is rolling from side to side. It is important for the electronic stability controller 28 to detect a change in the attitude of the towing vehicle 22 to predict a critical understeer/oversteer condition that may lead to an accident. The control system 20 utilizes the same information to determine when it is necessary to apply the braking system 24 of the trailer 26, independently of or in coordination with the brakes of the towing vehicle 22, to help stabilize the towing vehicle 22. It is contemplated that the control system 20 may apply the braking system 24, even when an operator of the vehicle does not directly apply the braking system 24 on the towing vehicle 22.

The various sensors of the electronic stability controller 28 may include a sensor chosen from a group of sensors comprising: a yaw rate sensor 30, a lateral acceleration sensor 32, and a steering angle sensor 34. It should be understood that the electronic stability controller 28 may include other sensors incorporated into the towing vehicle 22 other than specifically enumerated herein. The yaw rate sensor 30 and the steering angle sensor 34 detect the position, or change in position over time, of the towing vehicle 22 about the yaw axis Y, while the lateral acceleration sensor 32 detects the position, or change in position of the towing vehicle 22 about the pitch axis P.

The control system 20 further comprises an antilock braking controller 40. The braking controller 40 is preferably integrated into the towing vehicle 22 and includes a plurality of sensors for gathering data related to a braking condition of each wheel 42 on the towing vehicle 22. The sensors of the braking controller 40 may include a sensor chosen from a group of sensors comprising: at least one wheel speed sensor 36, and a brake pressure sensor 38. Preferably, the braking controller 40 includes a plurality of wheel speed sensors 36, which are located at each wheel 42 of the towing vehicle 22. The wheel speed sensors 36, located at each wheel 42 of the towing vehicle 22, sense the rotational speed of each wheel 42 to determine if one of the wheels 42 is slipping relative to the others. Typically, the brake pressure sensor 38 is located at a master cylinder of the towing vehicle 22, and senses the brake pressure applied to the wheels 42 of the towing vehicle 22. It should be understood that the braking controller 40 may include other sensors incorporated into the towing vehicle 22 other than specifically enumerated herein.

A trailer brake controller 44 is preferably integrated into a dash of the towing vehicle 22, and includes a processor 46 having a memory 48. The processor 46 and the memory 48 are in communication with the sensors 30, 32, 34 of the electronic stability controller 28 and are also in communication with the sensors 36, 38 of the antilock brake controller. The memory 48 of the processor 46 receives data associated with a yaw rate from the yaw rate sensor 30, a lateral acceleration from the lateral acceleration sensor 32, a steering angle from the steering angle sensor 34, a wheel speed from the wheel speed sensors 36, and a brake pressure from the brake pressure sensor 38. Accordingly, the various sensors, including the yaw rate sensor 30, the lateral acceleration sensor 32, the steering angle sensor 34, the wheel speed sensors 36, and the brake pressure sensor 38 are in communication with the memory 48 of the processor 46 for inputting the yaw rate, the lateral acceleration, the steering angle, the wheel speed, and the brake pressure into the memory 48 of the processor 46. The yaw rate, the lateral acceleration, the steering angle, the wheel speed, and the brake pressure may be inputted either directly into the trailer brake controller 44, or indirectly through the electronic stability controller 28 and the antilock braking controller 40.

The processor 46 calculates a desired braking force for the braking system 24 on the trailer 26, and signals an output that is responsive to the yaw rate, the lateral acceleration, the steering angle, the wheel speed, and the brake pressure. The output is commensurate with the desired braking force calculated by the trailer brake controller 44. The processor 46 coordinates the output, and thereby the actuation of the braking system 24 on the trailer 26, with the attitude of the towing vehicle 22 as directly measured by the various sensors 30, 32, 34, 36, 38 of the electronic stability controller 28 and the antilock braking controller 40 to increase the stability of the towing vehicle 22 during braking conditions, thereby increasing the stability of the towing vehicle 22 during extreme braking conditions. The electronic stability controller 28 signals the brakes on the towing vehicle to control the towing vehicle, when necessary. Preferably, the output from the processor 46 is coordinated with the signal from the electronic stability controller to the brakes on the towing vehicle to provide a coordinated output to the brakes on the towing vehicle and the braking system 24 on the trailer 26, to better control the towing vehicle 22 and the trailer 26 combination. It should be understood that the electronic stability controller 28 may also generate the desired braking force for the braking system 24 on the trailer, and send the output to the braking system 24 through the processor 46. It should also be understood that the output to the braking system 24 may be coordinated with the signal to the brakes of the towing vehicle 22 in some other manner not specifically described herein.

A typical braking system 24 on the trailer 26 being towed by the towing vehicle 22 will include electrically actuated brakes located at each of the wheels 42 of the trailer 26. If the trailer 26 includes the electrically actuated braking system 24, the output includes an electric signal sent through a conduit, such as a wire, to the trailer braking system 24 to activate the electric braking system 24 on the trailer 26. However, it should be understood that the trailer 26 may include a braking system 24 other than an electrically actuated braking system 24, such as a vacuum actuated braking system 24, or a hydraulic braking system 24. In which case, the output includes a vacuum pressure or a fluid pressure respectively sent through an appropriate conduit, such as a tube. It should be understood that the braking system 24 on the trailer 26 may include some other method of actuating the brakes on the trailer 26, and that the output may include any suitable method of actuating the braking system 24.

The processor 46 includes a program 50, which utilizes the yaw rate, the lateral acceleration, the steering angle, the wheel speed, and the brake pressure to determine the attitude of the towing vehicle 22, from which the appropriate desired braking force for the braking system 24 on the trailer 26 is calculated, and the appropriate output generated to assist in stabilizing the towing vehicle 22. An appropriate output may include activating the brakes only at certain wheels 42 of the trailer 26, or may include activating the brakes at all wheels 42 of the trailer 26 to apply the desired braking force to slow the trailer 26 as necessary to help stabilize the towing vehicle 22.

The control system 20 further comprises a switch 52 in communication with the processor 46. The switch 52 allows the operator of the towing vehicle 22 to manually activate the output. Accordingly, the operator of the vehicle may signal the processor 46 to send the output to the braking system 24 of the trailer 26 regardless of the various inputs received form the sensors 30, 32, 34, 36, 38 of the electronic stability controller 28 and the antilock braking controller 40.

The control system 20 further comprises an adjusting mechanism 54 in communication with the processor 46 for adjusting the output to compensate for variations, or variables, of the trailer 26, such as an empty trailer weight vs. a loaded trailer weight. Typically, the adjusting mechanism 54 includes a gain input control as is know in the art. The output may require adjustment due to an overall weight or weight distribution on the trailer 26. In other words, a loaded trailer 26 may utilize a different level of output than an unloaded trailer 26. However, it should be understood that some other method of adjusting the output may be utilized and still fall within the scope of the claims.

The control system 20 further comprises an output display 56 in communication with the processor 46 for displaying a message to the operator of the vehicle. The output display 56 may include a LCD display, an array of lights, or some other suitable manner of displaying a message. The message typically indicates whether or not the trailer braking system 24 is currently being activated, and may also include a measure of the output indicating the desired breaking force the trailer braking system 24 is being signaled to apply. The output display 56 may also include a message indicating the adjustment to the output, if any.

The subject invention also provides a method of actuating the braking system 24 on the trailer 26 towed by the towing vehicle 22. The towing vehicle 22 includes the trailer brake controller 44 comprising the processor 46 having the memory 48 as described above. The method includes the steps of determining a yaw rate of the towing vehicle 22 relative to a yaw axis Y of the towing vehicle 22; determining a lateral acceleration of the towing vehicle 22 relative to a pitch axis P of the towing vehicle 22; determining a steering angle of the towing vehicle 22; determining a brake pressure of the towing vehicle 22; and determining a wheel speed for at least one wheel 42 on the towing vehicle 22. As described above, the yaw rate, the lateral acceleration, the steering angle, the wheel speed, and the brake pressure are determined by the yaw rate sensor 30, the lateral acceleration sensor 32, the steering angle sensor 34, the brake pressure sensor 38, and the wheel speed sensor 36 respectively. Once determined, the method further comprises the step of inputting the yaw rate from the yaw rate sensor 30 into the memory 48 of the processor 46, inputting the lateral acceleration from the lateral acceleration sensor 32 into the memory 48 of the processor 46, inputting the steering angle from the steering angle sensor 34 into the memory 48 of the processor 46; inputting the brake pressure from the brake pressure sensor 38 into the memory 48 of the processor 46, and inputting the wheel speed from each of the wheel speed sensors 36 into the memory 48 of the processor 46.

The processor 46 then calculates the desired braking force for the braking system 24 on the trailer 26 in response to the inputted yaw rate, the inputted lateral acceleration, the inputted steering angle, the inputted brake pressure and the inputted wheel speed. After calculating the desired braking force, the processor 46 sends the output, commensurate with the desired braking force, to the braking system 24 on the trailer 26 to actuate the braking system 24. As described above, the output may include an electronic signal, a vacuum pressure, a fluid pressure, or some other signal appropriate to activate the braking system 24 on the trailer 26, and is responsive to the yaw rate, the lateral acceleration, the steering angle, the brake pressure, and the wheel speed of the towing vehicle 22.

The method further comprises the step of adjusting the calculated desired breaking force, and thereby adjusting the output. The output may need to be adjusted to accommodate different trailers 26 or different loads on the same trailer 26, i.e., the trailer 26 heavily loaded may require an adjusted output compensating for the extra weight to correctly apply the braking system 24 on the trailer 26.

The foregoing invention has been described in accordance with the relevant legal standards; thus, the description is exemplary rather than limiting in nature. Variations and modifications to the disclosed embodiments may become apparent to those skilled in the art and do come within the scope of the invention. Accordingly, the scope of legal protection afforded this invention can only be determined by studying the following claims

What is claimed is:

1. A method of actuating a brake on a trailer towed by a towing vehicle including a trailer brake controller having a processor with a memory, said method comprising:
determining a yaw rate of the towing vehicle relative to a yaw axis of the towing vehicle;
determining a lateral acceleration of the towing vehicle relative to a pitch axis of the towing vehicle;
determining a steering angle of the towing vehicle;
inputting the yaw rate, the lateral acceleration, and a steering angle into the memory of the processor;
calculating a desired braking force for the brake on the trailer in response to the inputted yaw rate, the inputted lateral acceleration, and the inputted steering angle;
sending an output to the brake on the trailer commensurate with the desired braking force to actuate the brake.

2. A method as set forth in claim 1 further comprising the step of determining a brake pressure of the towing vehicle.

3. A method as set forth in claim 2 further comprising the step of inputting the brake pressure into the memory of the processor.

4. A method as set forth in claim 3 further comprising the step of determining a wheel speed for at least one wheel on the towing vehicle.

5. A method as set forth in claim 4 further comprising the step of inputting the at least one wheel speed into the memory of the processor.

6. A method as set forth in claim 5 wherein the step of calculating a desired braking force is further defined as calculating a desired braking force in response to the inputted yaw rate, the inputted lateral acceleration, the inputted steering angle, the inputted brake pressure and the inputted wheel speed.

7. A method as set forth in claim 1 further comprising the step of adjusting the desired braking force to compensate for variables of the trailer.

8. A control system for actuating a brake on a trailer towed by a towing vehicle, said control system comprising:
an electronic stability controller including a yaw rate sensor, a lateral acceleration sensor, and a steering angle sensor for gathering data on a change in an attitude of the towing vehicle relative to a yaw axis and a pitch axis of the towing vehicle;
a trailer brake controller including a processor having a memory with said trailer brake controller in communication with said electronic stability controller for receiving data associated with a yaw rate from said yaw rate sensor, a lateral acceleration from said lateral acceleration sensor, and a steering angle from said steering angle sensor, with said trailer brake controller calculating a desired braking force for the brake on the trailer; and
an output responsive to said yaw rate, said lateral acceleration, and said steering angle and commensurate with the desired braking force for coordinating the actuation of the brake on the trailer with the attitude of the towing vehicle.

9. A system as set forth in claim 8 further comprising a braking controller having at least one wheel speed sensor in communication with said memory of said processor for determining a wheel speed of a wheel of the towing vehicle and for inputting the wheel speed into said memory of said processor wherein said output is responsive to said wheel speed.

10. A system as set forth in claim 9 wherein said at least one wheel speed sensor includes a plurality of wheel speed sensors.

11. A system as set forth in claim 9 wherein said braking controller further includes a brake pressure sensor in communication with said memory of said processor for determining a brake pressure of the towing vehicle and for inputting the brake pressure into said memory of said processor wherein said output is responsive to said brake pressure.

12. A system as set forth in claim 11 wherein said processor includes a program utilizing said yaw rate, said lateral acceleration, said steering angle, said wheel speed, and said brake pressure to calculate said desired braking force.

13. A system as set forth in claim 8 further comprising a switch in communication with said processor for manually activating said output.

14. A system as set forth in claim 8 further comprising an adjusting mechanism in communication with said processor for adjusting said output to compensate for variables of the trailer.

15. A system, as set forth in claim 14 wherein said adjustment mechanism includes a gain input control.

16. A system as set forth in claim 8 further comprising an output display in communication with said processor for displaying a message.
